(19) United States
(12) Patent Application Publication
(10) Pub. No.: US 2014/0111982 A1
(43) Pub. Date: Apr. 24, 2014

(54) TAPE-ON RETROFIT LEDS FOR FLUORESCENT TROFFERS

(71) Applicant: GE LIGHTING SOLUTIONS, LLC, Shelton, CT (US)

(72) Inventor: Glenn Howard KUENZLER, Beachwood, OH (US)

(73) Assignee: GE Lighting Solutions, LLC, Shelton, CT (US)

(21) Appl. No.: 13/654,725

(22) Filed: Oct. 18, 2012

(51) Int. Cl. F21V 21/00; F21V 19/00; F21V 7/00

(52) U.S. Cl. 362/217.05; 362/217.16; 29/825

(57) ABSTRACT

The present embodiments relate to a method and an apparatus to remove a fluorescent tube from a fixture and affix an adhesive side of a LED tape to a troffer of the fixture. The LED tape is electrically connected to the fixture.

### BACKGROUND

Many commercial building currently use recessed fluorescent lighting as a way of illumining office space. As illustrated in FIG. 1, a conventional fluorescent light fixture comprises a fluorescent tube 101, electrical sockets 103 and a troffer 102. A troffer may be defined as a long, recessed lighting fixture that is usually installed in an opening in the ceiling. Troffers are often made of stamped or folded metal structures.

Many light emitting diode (“LED”) suppliers are currently developing LED tubes to replace the fluorescent tubes 101. The LED tube is a direct replacement of the fluorescent tube and thus the LED tube can be retrofit into the large existing base of the fixture. However, LED tubes are expensive to produce and do not dissipate heat very well.

There remains a need in the art for an improved fluorescent tube 101 replacement that exhibits improved heat management and is less costly to manufacture than conventional LED tubes.

### SUMMARY OF THE INVENTION

Disclosed are an apparatus and a method for providing a fluorescent tube replacement that comprises a flexible substrate and a plurality of LEDs where the LEDs are electrically coupled to the flexible substrate.

### BRIEF DESCRIPTION OF THE DRAWINGS

FIG. 1 illustrates a conventional fluorescent light fixture.

FIG. 2 illustrates a top view of an LED tape according to some embodiments.

FIG. 3 illustrates a cross section of an LED tape according to some embodiments.

FIG. 4 illustrates a light fixture comprising an LED tape according to some embodiments.

FIG. 5 illustrates a method according to some embodiments.

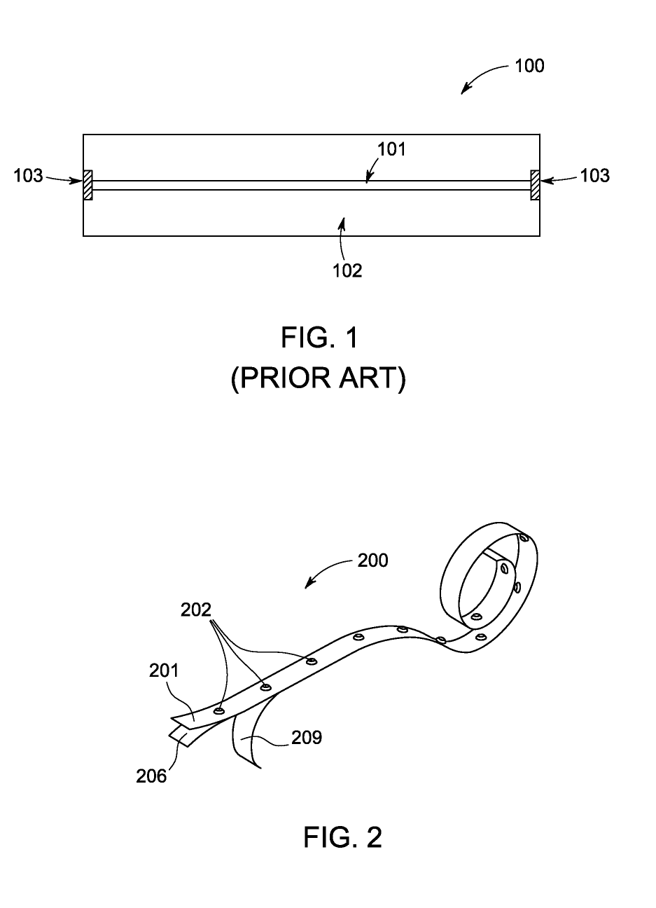

### DETAILED DESCRIPTION

The present embodiments relate to the replacement of fluorescent tubes by the application of an LED tape that is directly affixed to a lighting fixture (e.g., troffer). The apparatus may resemble a roll of tape with LEDs attached to the tape or a ribbon of LEDs.

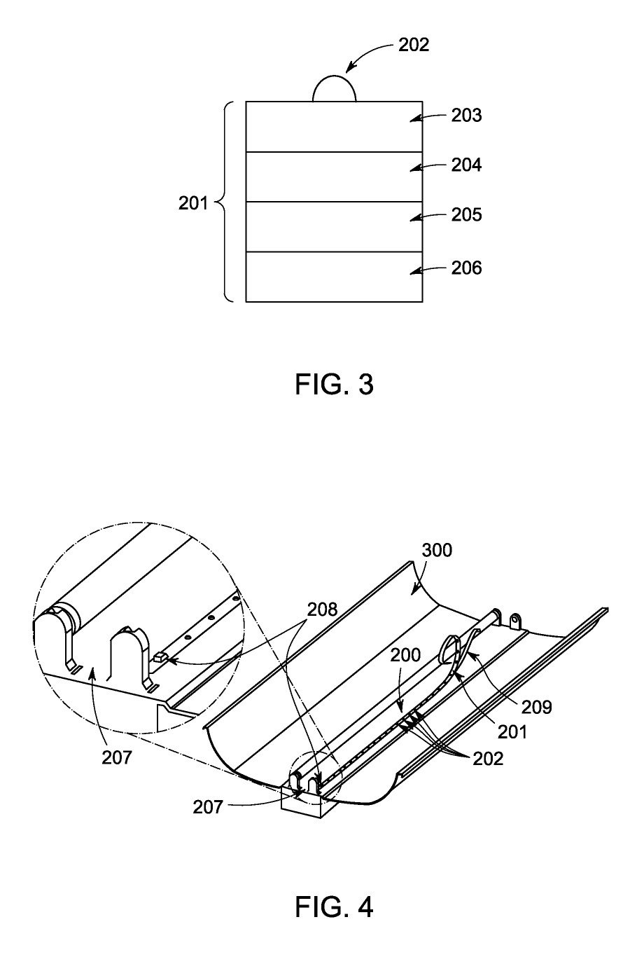

Referring now to FIGS. 2 through 4, an embodiment of an LED tape 200 is illustrated. The LED tape comprises a flexible substrate 201 and a plurality of LEDs 202. The flexible substrate 201 comprises a series of layers including a solder mask 203, a copper layer 204, a dielectric layer 205 and an adhesive layer 206. In some embodiments, the flexible substrate 201 may comprise a release liner 209. The release liner 209 may be releasably coupled to the adhesive layer 206 to prevent the adhesive layer 206 from adhering to itself. Furthermore, the release liner 209 may be used based on how a user is intending to affix the flexible substrate and/or a strength or “stickiness” of the adhesive layer 206.

The solder mask 203 may comprise a layer of a fusible metal alloy used to join together the plurality of LEDs 201 and copper layer 204. The copper layer 204 may comprise a thin copper strip where the copper has been etched (e.g., lithographically etched) to provide electrical tracings required for providing power to the plurality of LEDs 202. The copper layer 204 may be disposed between the solder mask 203 and the dielectric layer 205. The dielectric layer 205 may comprise a dielectric carrier film or an electrically insulating thermally conductive film and should be capable of heat transfer between the copper layer 204 and the adhesive layer 206 (e.g., the dielectric layer must provide good thermal conductivity with minimal thickness). For example, the dielectric layer 205 may comprise a material such as, but not limited to, Bergquist High Power Lighting Dielectric (“HPL”), DuPont Coolam LC or LX, Laird T-preg 1KA04, CoreSEM CoolRATE, or any other material comprising a thermal conductivity of at least 3.0 W/m-K.

An embodiment of an LED tape 200 affixed to a light fixture 300, as a retrofit for a fluorescent tube, is illustrated at FIG. 4. FIG. 4 illustrates a light fixture capable of utilizing two conventional fluorescent tubes. As illustrated in FIG. 4, the LED tape 200 is affixed to a troffer 207 of the light fixture 300 to replace a conventional fluorescent tube (e.g., one fluorescent tube is shown installed in the light fixture while another fluorescent tube is being retrofitted with the LED tape 200). Simply put, the LED tape 200 may be affixed using an adhesive side of the LED tape 200 to the troffer 207. The LED tape 200 may be sized in standardized fluorescent tube lengths. For example, the LED tape 200 may be substantially four feet long to replace a standardized four foot long fluorescent tube. However, in some embodiments, the LED tape 200 may be shorter or longer (e.g., one foot, two foot, six foot etc.) and a size may be based on a number of LEDs that the LED tape comprises (e.g., 50 LEDs per tape foot, 75 LEDs per tape foot, etc), sizes of the LEDs, and/or an amount of lumens desired. The LED tape 200 may be electrically coupled to the fixtures through electrical connectors 208. In some embodiments, a driver (e.g., a ballast) specific to the LED tape 200 may be installed in the fixture. The driver may convert a standard wall current to a current that is needed for the LED tape 200. The LED tape 200, as described above, may be flexible and capable of being coiled or rolled into a coil and then uncoiled without damage to any of the layers of the substrate 201 or the LEDs 202.

The light fixture 300 may comprise light emitting assembly that includes an elongated housing comprising at least one metallic section, and a light emitting apparatus adhesively mounted to the at least one metallic section of the housing. The light emitting apparatus comprises a substrate capable of being flexibly adhered to the housing. In some embodiments, the light emitting apparatus may comprise the LED tape 200. For example, the substrate may comprise a first side and a second side that comprises an adhesive layer. A plurality of light emitting diodes may be electrically coupled to the first side of the substrate. The plurality of light emitting diodes may be arrayed substantially longitudinally on a surface of the housing.

The housing is metallic and thus, may conduct heat. The substrate is capable of flexibly adhering (e.g., the substrate, in its final state, may no longer be flexible but may have been flexible at some time in its past). The housing comprises at least one reflective portion and/or at least one portion having a reflective material disposed thereover. In some embodiments, the housing comprises a shallow inverted box comprising an open face.

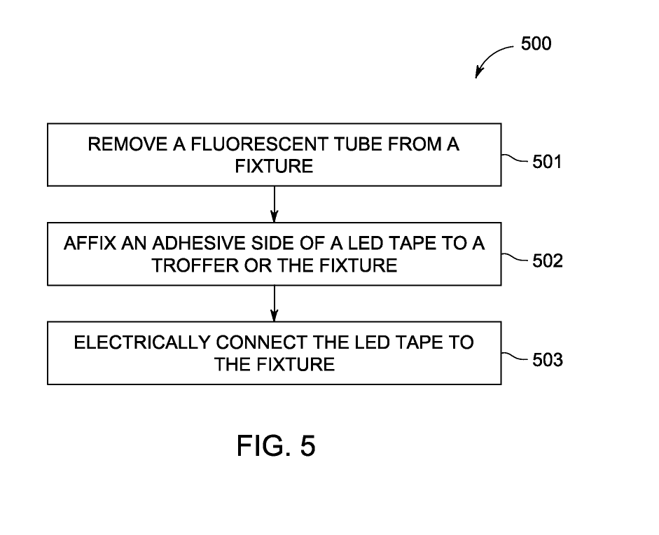

Now referring to FIG. 5, an embodiment of a method 500 of retrofitting a fluorescent fixture is illustrated. At 501, a fluorescent tube is removed from a fixture. Removing the fluorescent tube may be done in any conventional way such as rotating the fluorescent tube to disengage electrical contacts.

An adhesive side of the LED tape is affixed to a troffer of the fixture at 502. The LED tape 200 may comprise a first side comprising the LEDs and a second side comprising the adhesive. The adhesive side may be covered with a release liner that is removed prior to affixing the LED tape to the troffer. The adhesive side, such as the adhesive layer 206, may act as a double-sided tape (one side to the fixture and one side to the dielectric). As stated above, the LED tape may be flexible and by being flexible, an installer may peel off the release liner (e.g., a film coupled to an exposed side of the adhesive) and apply the LED tape directly to the fixture. Typical example of adhesives may comprise, but are not limited to, Toray TSA-33, Bergquist Bond-Ply, 3M transfer adhesive F9469PC, 3M Thermally conductive tape, 8805 or 8810, 3M Adhesive transfer tape, 9471LE, Kerafol Koolbond KL90-192, or Parker T412 thermally conductive attachment tape.

At 503, the LED tape is electrically coupled to the fixture. In some embodiments, the LED tape is electrically coupled to an appropriately selected driver associated with the LED tape. Because the LED tape is applied directly to the fixture, the LED tape can utilize the fixture as a heat sink, thereby eliminating the need to manufacture and supply heat sinks.

In some embodiments, the LED tape may be segmented so that the LED tape may be “cut” or separated based on a size of the troffer that the LED tape will adhere to. For example, the LED tape may be capable of being separated in even increments such as, but not limited to, 1 foot, or 6 inches. Utilizing a segmented LED tape, a roll of LED tape may be used to retrofit a four foot fixture by rolling out the tape to four feet and then separating the tape at a tape segmentation point. However, the tape can equally be rolled out and separated for a two foot fixture by rolling out the tape to two feet and then separating the tape at a tape segmentation point. Accordingly, the tape may comprise equally spaced segments with each segment having electrical connections that are connected to a next segment of the LED tape, or, when separated, the electrical connections can be electrically coupled to the electrical connections associated with the fixture.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A light emitting assembly comprising:
an elongated housing comprising at least one metallic section; and
a light emitting apparatus adhesively mounted to said at least one metallic section of the housing, the apparatus comprising:
a substrate flexibly adhered to the elongated housing, said substrate comprising a first side and comprising a second side comprising an adhesive layer, and a plurality of light emitting diodes electrically coupled to the first side of the substrate.

2. The light emitting assembly of claim 1, wherein the plurality of light emitting diodes are arrayed substantially longitudinally on a surface of the housing.

3. The light emitting assembly of claim 1, wherein the housing comprises at least one reflective portion and/or at least one portion having a reflective material disposed thereover.

4. The light emitting assembly of claim 1, wherein the housing comprises a shallow inverted box comprising an open face.

5. The light emitting assembly of claim 1, wherein the flexible substrate is segmented in equally spaced segments with each segment having electrical connections connected to a next segment of the flexible substrate.

6. A method of retrofitting a fluorescent fixture comprising:
affixing an adhesive side of a LED tape to a metallic section of the fixture; and
electrically connecting the LED tape to the fixture.

7. The method of claim 6, wherein the LED tape comprises:
a solder mask disposed between a plurality of light emitting diodes and a copper layer; and
a dielectric layer disposed between the copper layer and an adhesive layer, wherein the adhesive side of the LED tape comprises the adhesive layer.

8. A light emitting assembly comprising:
a fixture comprising at least one metallic section; and
a light emitting apparatus adhesively mounted to said at least one metallic section of the fixture, the apparatus comprising a substrate flexibly adhered to the fixture, said substrate comprising a first side and comprising a second side comprising an adhesive layer, and a plurality of light emitting diodes electrically coupled to the first side of the substrate, the assembly made by the method of claim 6.

9. The light emitting assembly of claim 8, wherein the substrate comprises:
a solder mask disposed between the plurality of light emitting diodes and a copper layer; and
a dielectric layer disposed between the copper layer and the adhesive layer.

10. The light emitting assembly of claim 8, wherein the dielectric layer comprises a thermal conductivity of at least 3.0 W/m-K.

11. The light emitting assembly of claim 8, wherein the light emitting apparatus is substantially four feet long.

12. The light emitting assembly of claim 8, further comprising:
a first electrical connection at a first end of the light emitting apparatus; and
a second electrical connection at a second end of the light emitting apparatus.

13. The light emitting assembly of claim 8, wherein the substrate is segmented in equally spaced segments with each segment having electrical connections connected to a next segment of the substrate.

14. A light emitting apparatus comprising
a plurality of light emitting diodes;
a flexible substrate comprising a first side and a second side comprising an adhesive layer, the plurality of light emitting diodes electrically coupled to the first side of the flexible substrate, where the flexible substrate comprises:
a solder mask disposed between the plurality of light emitting diodes and a copper layer; and
a dielectric layer comprising a thermal conductivity of at least 3.0 W/m-K, the dielectric layer disposed between the copper layer and the adhesive layer.

15. The light emitting apparatus of claim 14, further comprising:
a first electrical connection at a first end of the apparatus; and
a second electrical connection at a second end of the apparatus.

16. The light emitting apparatus of claim 14, wherein the flexible substrate is segmented in equally spaced segments with each segment having electrical connections connected to a next segment of the flexible substrate.
